(19) United States
(12) Patent Application Publication
(10) Pub. No.: US 2011/0052751 A1
(43) Pub. Date: Mar. 3, 2011

(54) FEED COMPOSITION FOR COMPANION ANIMALS

(76) Inventors: Martin Karutz, Magden (DE); Stephanie J.M. Krammer-Lukas, Lorrach (DE)

(21) Appl. No.: 12/682,278

(22) PCT Filed: Oct. 8, 2008
(86) PCT No.: PCT/EP08/08463

§ 371 Date: Nov. 1, 2010

(30) Foreign Application Priority Data
Oct. 10, 2007 (EP) 07019820.5

(51) Int. Cl. A23K 1/18; A23K 1/00; A23K 1/16

(52) U.S. Cl. 426/2; 426/607; 426/602; 426/98

(57) ABSTRACT

The present invention relates to animal feed compositions which are useful for balancing body weight in companion animals and which after ingestions results in reduced calorie intake at a subsequent meal. It has been found surprisingly that the calorie intake of a pet can be reduced without negative effects towards the begging behavior of the unsatisfied pet which often results in a over-feeding by the owner when the daily feed intake of the diet (preferably a calorie-restricted diet) is combined with the intake of a mixture of triglyceride oils having a solid fat content at ambient to body temperature and an emulsifier, a mixture hereinafter abbreviated by “oil-composition”.

The present invention relates to animal feed compositions which are useful for balancing body weight in companion animals and which after ingestions results in reduced calorie intake at a subsequent meal.

The term “companion” as used herein includes dogs, cats, horses, donkeys, ornamental birds, mini pigs, reptiles and small pets, e.g., chinchillas, guinea pigs, degus, mice, gerbils, hamsters, rats, ferrets and lagomorphes, e.g., rabbits. Animals of all ages are included, e.g. young animals, adults, animals of medium age and seniors. Of primary interest with respect to the present invention are rodents, horses and pets as dogs and cats, at all shapes and body constitution (normal weight, overweight, obese).

Over-consumption of calorie resulting in excess body fat is believed to be the most prevalent form of malnutrition in pets. This may result in overweight and finally in obesity, a problem of increasing importance not only in human beings but also in pets. The discrepancy between energy intake and daily exercise leads to increased bodyweight with negative consequences for general health, such as increased risks for various diseases. The problem can affect animals of all ages and genders. It is aggravated by the metabolic changes due to neutering and by the changes in peoples' lifestyles that permit them less time for their animal, thus decreasing the amount of exercise the animal gets.

Diseases that have been associated with overweight and obesity in dogs and cats include diabetes, hypertension, neoplasias, impaired immune response, pancreatitis, hepatic lipidosis, urolithiasis, musculoskeletal problems, respiratory and cardiovascular disease, skin disease and arthritis.

Obesity develops when animals are in positive energy balance for an extended period of time. This occurs when energy intake increases, energy expenditure decreases or both. Under most circumstances, homeostatic mechanisms control energy intake and maintain body composition at or near some “set point.” Several risk factors contribute to positive energy balance and/or affect the body's compositional set point. Genetics, gender, age, physical activity and caloric composition of foods have been demonstrated as risk factors for positive energy balance, weight gain and obesity. These risk factors must be understood if obesity is to be prevented or treated effectively.

Presently there are a lot of, so called “calorie-restricted”, diets for weight loss and weight control (continued maintenance) available on the market. One example Purina® Fit & Trim®, which contains fibres that help keep dogs from feeling hungry. Another example is Iam's Weight Control™ Large Breed, which contains 20% less fat than Iams Large Breed™. L-carnitine as component of this diet helps to burn fat.

If the cause for obesity is simple caloric excess, and the treatment only requires caloric restriction, then why do some animals fail to lose weight, even when the animals are fed with a calorie-restricted diet?

In order to answer this question, it is important to emphasize that the efficacy of dietary treatment depends not only on diet selection it depends also on the feeding method.

One of the main driving forces in weight maintenance is appetite and satiety. Most people and animals will maintain their adult weight within a fairly narrow range over many years. The reason is both appetite and satiety have long-term and short-term regulators with tremendous redundancy. This redundancy of regulation is why appetite control is probably the biggest stumbling block to successful weight control.

Animals and humans seem to have an innate set point for body weight or, more appropriately, body fat. This set point is determined, in part, by the number of fat cells within the body but also by factors, such as genetic makeup, which are less well understood. The amount of body fat is now thought to be controlled in rats and humans by a peptide, leptin, secreted directly from the fat cell. And similar relationships are observed in dogs and cats. This represents a form of negative feedback. When fat stores are low leptin is low. Low hypothalamic leptin results in increased Neuropeptide Y (NPY) which stimulates appetite. This continues until fat stores are replenished and leptin is released at levels sufficient to inhibit secretion of NPY. This is the purported mechanisms of the lipostatic theory of food intake. We can reduce a pet's caloric intake by feeding smaller quantities or reducing the energy content of a diet. The animal will successfully lose weight. However, without continued food or caloric restriction the pet will increase its food consumption until the body weight returns. A host of peripheral and central peptides influence satiety with the advantage seemingly in favor of appetite support and weight maintenance.

Non-compliance is a common reason for failure of weight loss therapy. Non-compliance by the pet occurs because it is striving to maintain its set-point. Owner compliance is often poor due to social/psychological factors important to a particular client-pet relationship and also due to begging behavior of the pet. A study found that feeding was of crucial importance and there was a lack of discipline toward feeding. These issues must be recognized and addressed for successful weight loss to occur.

Therefore there is still the need to keep pet owners from over-feeding the pet especially with calorie restricted diets. It is well known that products with a high fat content bring about a feeling of satiety. It would, however, be desirable to have a feed product which provides a more rapid onset of such a feeling of satiety, which produces a feeling of satiety for a longer period of time or which produces the same feeling of satiety at a lower caloric intake. Also desirable would be a product which, when consumed, leads to a reduced caloric intake at a later meal.

It has now been found surprisingly that the calorie intake of a pet can be reduced without negative effects towards the begging behavior of the unsatisfied pet which often results in a over-feeding by the owner when the daily feed intake of the diet (preferably a calorie-restricted diet) is combined with the intake of a mixture of triglyceride oils having a solid fat content at ambient to body temperature and an emulsifier, a mixture hereinafter abbreviated by “oil-composition”.

With the phrase “having a solid fat content at ambient to body temperature” it is meant that there should be a solid fat content in the whole interval between ambient and body temperature. The meaning of “a solid fat content” is known to the skilled person and may be determined using standard methodology, as for instance is provided at www.minispec.com/applications/solid_fat_content.html. Expressed in another way, the term means that there should be at least a residual and detectable solid fat content at body temperature. Residual and detectable solid fat contents may be in the order of more than 0.1%, such as 0.5%, 1%, 2%, 3%, 5%, 10% or more. Solid fat content may be determined by Benchtop NMR Using ISO 8292 or IUPAC 2.150 methods. These methods yield a melting curve from which it can be easily determined whether a given triglyceride oil has a solid fat content in the range of ambient to body temperature.

Ambient temperature is used to indicate approximate room temperature being the temperature wherein the composition is used according to the invention. Usually this is approximately 20° C., such as 18, 19, 20, 21 or 22° C.

The term “Triglyceride” as used herein refers to triacylglycerol, which is glycerol esterified to three fatty acids.

In particular the inventors have been able to demonstrate that said oil-composition, used in synergy and in combination with an appropriate amount of a pet diet, exhibits, in a totally unexpected manner, the effects sought by the present invention when the oil-composition is for example fed to the animal on a daily basis 1 to 8 hours before the regular diet or supplemented to regular pet food offered at the same time.

Accordingly the present invention relates to an animal feed composition for balancing body weight, i.e. reducing calorie uptake, comprising a mixture of animal feed composition for reducing calorie uptake comprising a mixture of triglyceride oils having a solid fat content at ambient to body temperature and an emulsifier.

This aspect encompasses various farms of animal feed diets, as for example dry and wet pet food, treats and other snacks, as for example yoghurt based morning snacks and paste supplements.

Animal feed including pet food compositions advantageously include food intended to supply necessary dietary requirements, as well as treats (e.g., dog biscuits) or other food supplements. In preferred embodiments the feed comprises a basal diet and additionally the composition(s) according to the invention. The animal feed comprising the composition according to the invention may be in the form of a dry composition (for example, kibble), semi-moist composition, wet composition, or any mixture thereof. Alternatively or additionally, the animal feed is a supplement, such as a gravy, drinking water, yogurt, powder, suspension, chew, treat (e.g., biscuits) or any other delivery form.

A further aspect of the invention relates to a supplement composition comprising said mixture, as for example dry powdered supplements and tablet supplements.

The present invention also relates to a method and/or to the use of a oil-composition as defined above or an oil-in-water emulsion thereof, for balancing and maintaining body weight by giving a rapid, improved and prolonged feeling of satiety, for reducing calorie intake at later meals and selectively producing a greater reduction in fat consumption, for a reduction of weight and/or fat, and/or for the prevention and treatment of cardiovascular diseases and diabetes.

The use according to the invention especially helps to reduce feed uptake and to control calorie intake to maintain weight after weight reduction (“maintaining weight loss”) and therefore helps to reduce body mass, it contributes to weight loss and slimming down, it improves body composition and reduces the risk for regaining weight (yoyo-effect).

The terms “weight maintenance” or “maintaining weight loss” imply keeping an approximate weight loss result that may have been accomplished by treatment interventions or by one's own efforts, for a period of at least 18 weeks. More in particular, the term “weight loss” refers to achieving a weight loss of at least 2% of initial or baseline body weight, such as 3, 4, 5, 7, 10 or even 15%. A weight loss may be considered maintained when weight regain, 18 weeks after the end of a period of weight loss, as a % of weight loss, does not exceed 35%, such as 30, 25, 20 or even 15% or less.

This aspect encompasses various application/feeding concepts, for example a method of co-feeding of an animal with an oil-composition as specified hereinabove (for example Fabuless® as supplied by DSM Food Specialties, Netherlands) together with a pet food diet, for example a calorie restricted diet.

A second aspect of the present invention is the use of the oil-composition for reducing the weight of companion animals. In a preferred embodiment of this object the oil-composition is used in combination with other functional ingredients as for example L-carnitine or EGCG (Epigallocatechin gallate), which helps to burn fat.

This aspect further encompasses the use or a method for treatment, or prophylaxis of obesity in companion animals, the method comprising administering compounds according to the invention to that animal.

The compounds of the invention may be further used (i) in therapy, i.e. for treatment of obesity and diseases associated with obesity as for example cardiovascular disease, diabetes and arthritis, and/or (ii) for prophylaxis, i.e. treatment to prevent the onset of obesity and related diseases.

The principle mechanism is a delayed digestion of the fat component of the product, leading to the presence of free fatty acids in the distal jejunum and ileum. These fatty acids are thought to trigger the so-called “ileal brake” mechanism. The ileal brake is a physiological mechanism to ensure better digestion of nutrients. When nutrients are still present in the distal ileum, gastric emptying and gut movement are slowed down to permit better digestion of the gut contents. At the same time a feeling of satiety is created, reducing appetite. There is no influence on the digestion in general or on the digestion of other nutrients ingested with or after the emulsion.

In a preferred embodiment of the invention the triglyceride oils are used in form of an oil-in water emulsion. The oil of the emulsions can be any triglyceride material having a solid fat content at ambient to body temperature. The triglyceride oils are defined by the percentage of solid fat content, determined by NMR serial measurements as described in IUPAC method no. 2.150, 7th edition.

The amount of triglyceride oils (wt %) may vary depending on the envisaged application and the nature and characteristics of the triglyceride oil as is taught herein. It can be envisaged that a composition according to the invention contains 5, 10, 15, 20, 30, 40, or even 60 or more wt % of triglyceride oils up to maximum dispensability, i.e. when there is still a water continues phase.

The triglyceride oils are preferably selected from the group consisting of palm oil, cocoa butter or other confectionery fats. Further examples of triglyceride oils are illipe butter, shea butter, kokum butter, sal butter or other natural oils or fractions thereof with a similar solid fat content or melting range. Other examples of such oils are hydrogenated or partly hydrogenated soybean oil, rapeseed oil, cotton oil and sunflower oil or fractions thereof. The triglyceride oils may also be synthetic or semi-synthetic.

The term “confectionary fat” refers to special fats for confectionary applications and is known in the art. Cacao butter is the best known representative of this group, confectionary fats are also often referred to as cacao butter alternatives or cacao butter equivalents, sometimes also as cacao butter replacers or cacao butter substitutes.

The term synthetic or semi-synthetic refers to substances that are not entirely natural and/or obtained by chemical synthesis.

The triglyceride oils should (may/preferably?) contain at least 90% by weight of triglycerides, preferably more than 95% by weight.

The invention especially refers to a composition wherein the triglyceride oils are a fraction of palm oil. This fraction of palm oil is obtained from commercial palm oil, which is fractionated to specific mixtures of suitable triglycerides, based on the combination of mainly palmitic, oleic, linoleic and stearic esters of glycerol, respectively. Preferably the content of triglycerides in the palm oil fraction should be not less than 99% by weight. The purity can be checked by conventional chromatographic methods, such as thin-layer chromatography or high-performance liquid chromatography.

Preferred fatty acids for use in the invention are therefore selected from the group consisting of palmitic acid, oleic acid, linoleic acid and stearic acid. Even more preferred compositions comprise at least two fatty acids selected from the group consisting of palmitic acid, oleic acid, linoleic acid and stearic acid. Particularly good results were achieved when 20-80%, such as 30-70% of fatty acids were used selected from the group consisting of palmitic and stearic acid, and 80-20%, such as 70-30% fatty acids selected from the group consisting of oleic and linoleic acid. It should be noted that these amounts do not necessarily have to add up to 100%, i.e. they do not necessarily exclude the presence of additional fatty acids such as lauric acid.

Emulsifiers are generally esters composed of a hydrophilic and a lipophilic part. In general, the lipophilic part is composed of stearic, palmitic, oleic, or linoleic acid or a combination of said fatty acids. The hydrophilic part is generally composed of hydroxyl, carboxyl, or oxyethylene groups.

Examples of emulsifiers are lecithins, mono- and diglycerides, propylene glycol monoesters, lactylated esters, polyglycerol esters, sorbitan esters, ethoxylated esters, succinylated esters, fruit acid esters, acetylated mono and diglycerides, phosphated mono- and diglycerides and sucrose esters. The emulsion of the triglyceride oils can also be obtained when the oils are mixed with suitable feeds or feed products, making use of the inherent emulsification properties of said feeds or feed products. Feed emulsifiers according to the invention should be able to emulsify more than 20% by weight of the triglyceride oils, preferably more than 40% by weight, giving an emulsion which is still liquid in order to facilitate the processing of a feed product in which the emulsion is incorporated.

A preferred emulsifier of the invention is lecithin, for instance produced from egg yolk, milk, soybean oil, sunflower oil, and rapeseed oil, which consists of a mixture of mainly phospholipids, such as phosphatidylcholine and phosphatidylethanolamine. Lecithin refers in this context to crude mixtures of said phospholipids which are obtained on degumming of the starting materials, and which are commercially available as feed emulsifiers.

A particularly preferred emulsifier is a galactolipid based emulsifier. Galactolipids belong to the group of glycolipids, well known constituents of plant cell membranes. The most important classes of these contain one to four sugars linked glycosidically to diacylglycerol. The two most abundant classes contain one and two galactose units, respectively, and the commonly used nomenclature and abbreviations of these are mono- and digalactosyldiglyceride (MGDG and DGDG), sometimes referred to as galactolipids. Galactolipids, primarily DGDG and DGDG-rich materials, have been investigated and found to be a surface active material of interest in industrial applications such as food, cosmetics, and pharmaceutical products. Galactolipid emulsifiers are described in WO 95/20943 and WO 97/11141. Preferred sources for the galactolipid emulsifiers are cereals and grains, particularly oats.

Various examples of oil-compositions in form of emulsions which may be used according to the invention are described in EP 0 994 655 which is hereby incorporated by reference.

In another preferred embodiment of the invention the triglyceride oils are used in form of a solid composition, which comprises a particulate solid non-lipid carrier and an oil-in-water emulsion on the carrier capable of being released from the carrier on contact with aqueous media to form an oil-in-water emulsion in said aqueous media.

It is preferred for the particulate solid composition to be free-flowing so as to be capable of being processed in equipment used in animal feed industry.

The carrier is preferably selected from foodstuff of vegetable, animal or mixed origin. Preferably the carrier is capable of passing at least the upper part of the gastro-intestinal tract substantially unchanged. According to on preferred aspect, the carrier is preferably substantially insoluble in water but may swell in contact with water. According to an alternative preferred aspect, the carrier is partially or fully soluble in water. Preferred carriers are comprised by the group consisting of starch, modified starch, proteinaceous material such as whey protein, soy protein and casein, other material of vegetable origin such as material originating from oat bran, rice hulls, ground seeds, etc., gums such as gum arabic, pectins, xanthans, and carrageenans. In addition to organic carrier materials inorganic carrier materials used in the foodstuff industry, such as sodium chloride, calcium carbonate, and calcium phosphate, may be used in certain applications. It is also within the scope of the invention to use mixtures of the carrier materials. In principle, any edible solid particulate carrier material that does not interact, at least not to a substantial degree, with the oil-in-water emulsion in an irreversible manner preventing it from being released on contact with aqueous media to form an oil-in-water emulsion in said aqueous media may be used.

It is preferred for the composition to comprise from 0.1% by weight to 90% by weight of oil-in-water emulsion as specified hereinabove and from 10% to 99.9% by weight of carrier; more preferred from 0.5% by weight to 60% by weight of oil-in-water emulsion and from 99.5% by weight to 40% by weight, most preferred to 30% by weight of oil-in-water emulsion and from 60% by weight, most preferred from 70% by weight, to 99.5 by weight of carrier.

The term aqueous media as used herein comprises water, aqueous solutions of salts such as sodium chloride and/or of organic compounds such as glucose and/or fructose but also aqueous suspensions and/or emulsions of organic material, such as skimmed milk and even gastric fluids. It is preferred for the solid composition to release more than 50% by weight, more preferred more than 75% by weight, of its oil-in-water emulsion on contact with an aqueous media at a temperature of below 75° C., more preferred of below 50° C., more preferred of below 40° C., most preferred at about 35° C.

As mentioned above, the invention refers in a first aspect to the use of a mixture of triglyceride oils, for example of an oil-in-water emulsion thereof for giving to the animal a prolonged feeling of satiety, as well as a reduction in calorie intake and especially a selective reduction in fat intake at subsequent meals. The satiety effect is most noticeable during the period of 1 to 8 h after intake.

For that purpose, the oil-composition according to the invention may be
included in a regular animal feed diet, for example pet food/pet nutrition product;
supplemented to regular diet offered at the same time (separate, topping or mixed);
supplemented to regular animal diet offered at a different point in time, preferentially 1 to 8 hours before regular diet;
included in a snack specifically applied for delivering the oil-composition as e.g. morning, noon and/or evening snack; potentially designated as meal replacer.

In a preferred embodiment of the invention, the oil-composition according to the invention is an oil-in-water emulsion as for example Fabuless®. In order to obtain a prolonged feeling of satiety said oil-composition being used in an amount sufficient to provide a daily dosage of 6 mg fat per kg body weight to about 280 mg fat per kg body weight, preferably 30 mg fat per kg body weight to about 89 mg per kg body weight, of the subject to which it is to be administered, wherein the quantities are dependent on the feeding concept and on the animal species.

In another embodiment of the invention, the oil-composition according to the invention may be administered to the animal 1 to 8 hours, preferably 1 to 5, most preferentially 1 to 4 hours before regular diet. The composition used in such a feeding concept is preferably included in a snack specifically applied for delivering the oil-composition as morning, noon and/or evening snack.

The invention also refers to the use of the oil-composition in combination with a calorie restricted diet in order to reduce body weight and/or for the preparation of a pharmaceutical composition for the prophylaxis and treatment of over weight and/or obesity, for the control of calorie or fat intake and for the prevention and treatment of cardiovascular diseases and diabetes in pets.

When used in a feed or pharmaceutical composition for weight reduction, for control of calorie intake or the prevention or treatment of any appropriate disease, such as cardiovascular disease or diabetes, the composition can comprise in addition to the oil in-water emulsion other ingredients as L-carnitine or EGCG and/or any other therapeutically active substance.

The invention also refers to a pet food product containing an oil-composition as specified hereinabove.

More particularly, this invention also relates to the use of a composition as defined above as a component of animal feed or liquid products (as for example drinking water or cat milk) or feed or liquid supplements, as well as to compositions, supplements, liquids and feed containing them.

The feed composition/diet according to the invention encompasses dry pet food, wet pet food, semi-moist pet food, any kind of treats and chews (baked, extruded, injection molded) or other snacks (yoghurt) combining nutritional value with the benefits of the oil-composition, for example Fabuless®.

Other animal feed products, which may contain the oil-composition as specified hereinabove are products for hydration such as water and milk based liquids or processed forms of it (as for example powdered milk replacer) and any kind of nutritious pet product such as bones, rawhide, meaty snacks, which allow topical application of either form of oil-compositions as specified hereinabove by dipping, dusting or any other way of inclusion.

The feed supplement composition according to the invention may be a ‘stand-alone’ supplement as powder, tablet (e.g. pressed), capsule (e.g. soft gel) liquid, paste or any other galenic form to deliver the emulsion as described above. The ‘stand-alone’ supplement may optionally comprise additional functional ingredients as for example L-carnitine, vitamins, antioxidants as for example vitamin E, EGCG and resveratrol.

In general, the final feed product may be manufactured by mixing the oil-composition with one or more carrier (including any supporting filler, etc.), optionally transferred into other galenic form (tablets, etc.) after mixing. The oil composition may also be dusted on prefabricated pet food products, with or without additional coating prior or after the application of the oil-composition. The oil-composition may also be mixed into feed matrix at any stage of processing (e.g. prior and after mixing, extrusion, molding, baking, retorsion, phase separation etc.). The oil-composition may also added to pet food products by dipping those in a liquid form of the composition, for example Fabuless®, with or without additional coating prior or after the application of the composition.

Different product forms according to the invention may be manufactured and/or used as follows:
Dry powdered supplement: Fabuless® in a matrix containing a carrier (e.g. starch), a palatant (e.g. yeast extract) and optionally other functional ingredients (e.g. vitamins) is filled into sachet; optionally added in a package of pet food.
Tablet supplement: Dry powdered supplement as above is pressed as tablet or filled into capsule.
Yoghurt snack: Skimmed yoghurt containing Fabuless® and optionally one or more palatants and/or other functional ingredients is applied as morning snack; optionally sold in combination with regular or specific pet food.
Paste supplement: Paste containing Fabuless® mixed in solution with one or more carrier (including any supporting filler) as for example fibers, palatants, proteins, polysaccharides, fat replacer, optionally followed by reduction of water content.
Dry pet food: Extended dry pet food is coated with liquid form of Fabuless® or dusted with powdered form of Fabuless®, optionally coated with fat and/or palatant.
Wet pet food: Pate containing Fabuless® is added to a standard net pet food, optionally exchange fat by fat replacer, to a concentration of 1%.

Typical components of dry, canned, semi-moist or baked pet food forms, in addition to the inventive composition, are crude protein, crude fat, carbohydrates (NfE), starch, crude fibers, and ash, further on minerals, trace elements, vitamins, fatty acids, protein and amino acids, choline, carnitine, dietary fiber and substances required for balanced diets of the different animal species. Basic ingredients of such food compositions are
Crude Protein including proteins and N-containing compounds of non-proteinaceous nature, e.g. acid amides, amines, free amino acids, ammonium salts, alkaloids;
Crude Fat including neutral fats, lipoids (phospho-, sphingolipids, steroids) and other ethersoluble compounds;
N-free Extractions (NFE) including polysaccharides (starch, glycogen), soluble saccharides (glucose, fructose, saccharose, lactose, maltose and oligosaccharides), and soluble fractions of cellulose, hemicellulose, lignin and pectins;
Crude Fibers including insoluble fractions of cellulose, hemicellulose, lignin and other components of the cell wall like suberin, cutin etc.;
Ash including minerals (macrominerals such as calcium, phosphorus, sodium, chloride, potassium, magnesium, and microminerals, i.e., trace elements, such as iron, copper manganese, zinc, iodine, selenium,) and further inorganic substances e.g. silicate.
Vitamins including vitamins A, B1, B2, B6, B12, D, pantothenic acid, niacin, biotin, folic acid, linolic acid and choline.

Further components may, e.g. be omega-6-fatty acids, omega-3-fatty acids, L-carnitine, chondroitin sulfate, glucosamine, glutamine/glutamic acid, arginine, taurine, hydroxyproline, pre- and probiotics.

The invention described and claimed herein is not to be limited in scope by the specific embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

The following examples further illustrate the invention.

### EXAMPLE 1

### Wet Dog Food Comprising a Oil-Composition as Defined Above

Commercial basal diet for dogs (e.g. Pedigree Moist) is mixed with Fabuless® in an amount sufficient to administer to a subject a daily dose of 30 mg to 89 mg fat per kg body weight.

### EXAMPLE 2

### Wet Cat Food

Commercial basal diet for cats (e.g. Happy Cat “Adult”, Tierfeinnahrung, Südliche Hauptstraβe 38, D-86517 Wehringen, Germany) is mixed with Fabuless® in an amount sufficient to administer to a subject a daily dose of 30 mg to 89 mg fat per kg body weight.

### EXAMPLE 3

### Dog Trial

40 adult beagle dogs have been offered a morning snack (8 am) in terms of wet dog food (Pedigree Moist), in an amount which will account for approximately 15% of the dogs' daily energy requirements. 4 hours after the morning snack (12 noon), all dogs have been be offered their habitual dry dog food (Purina Dog Chow Maintenance) in amounts exceeding the dogs' energy requirements (500 g). After an adaption period of 7 days one group of animals have been supplemented with Fabuless at 8.00 am, and then their feed intake have been monitored from 10 am until 2 pm for a period of 7 days. The results have been compared with the results of a control group.

Test item

| | |
|---|---|
| Oil-in water emulsion | |
| Identification | FABULESS 28% CUPS |
| Specification/g | 280 mg/1000 mg |
| Storage conditions | Store cool and protected from light and humidity |
| Control item | |
| Identification | (Commercially available) sunflower oil |
| Storage conditions | Store cool and protected from light and humidity |

The results can be summarized as follows:
Feeding regime has a significant influence. Best results have been observed when 4 hours before the regular diet Fabuless® is administered to the animal.
Animals with high food intake reduced food consumption when supplemented with Fabuless® by 12%.

### EXAMPLE 4

### Cat Trial

Within this trial 21 cats have been offered the test substance (Fabuless®) mixed with small amounts of highly palatable wet cat food for 7 days.

Firstly, 42 cats have been allowed a 7-day adaptation period to acclimatize to a new feeding regime: the adult cats have been offered a morning snack (8 am) in terms of wet cat food (Friskies® Moist) in the amount (20 g) that has been evaluated in the pilot trial as optimal for complete consumption of the test substance. Four hours after the morning snack (12 noon), all cats have been offered their habitual dry (Purina® Cat Chow® Maintenance) cat food in amounts exceeding the cats' requirements (150 g). Another four hours later (4 pm) the leftover food have been weighed back and the meal left with the cats over night and weighed back in the morning before offering the morning snack. After the adaption period the animals have been supplemented with Fabuless at 8.00 am, and then their feed intake have been monitored from 10 am until 2 pm for a period of 7 days. The results have been compared with the results of a control group.

Test item

| | |
|---|---|
| Oil-in water emulsion | |
| Identification | FABULESS 28% CUPS |
| Specification/g | 280 mg/1000 mg |
| Storage conditions | Store cool and protected from light and humidity |
| Control item | |
| Identification | Commercially available sunflower oil |
| Storage conditions | Store cool and protected from light and humidity |

The results can be summarized as follows:
Feeding regime has significant influence. Best results have been observed when 2 hours before the regular diet Fabuless® is administered to the animal.
Animals with high food intake reduced food consumption when supplemented with Fabuless® by 16%.

1. Animal feed composition for reducing calorie uptake comprising a mixture of triglyceride oils having a solid fat content at ambient to body temperature and an emulsifier.

2. Animal feed composition according to claim 1, wherein the triglyceride oils are combined with other lipids containing essential fatty acids.

3. Animal feed composition according to claim 1, wherein the mixture is an oil-in-water emulsion of the triglyceride oils and wherein the triglyceride oils are selected from the group consisting of palm oil, cocoa butter and other fats having a solid fat content at ambient to body temperature.

4. Animal feed composition according to claim 3, wherein the triglyceride oils are a fraction of palm oil.

5. Animal feed composition according to claim 3, wherein the feed emulsifier is a lecithin or a galactolipid based emulsifier.

6. Animal feed composition according to claim 3, wherein the mixture of the oil phase of the emulsion comprises 80-99% by weight of triglyceride oils and 1-20% by weight of emulsifier.

7. A feed product for companion animals, preferably a pet food product, or a feed supplement product which comprises an animal feed composition according to claim 1.

8. A feed product for companion animals comprising 1-30% by weight, preferably 2-15% by weight of the oil-in-water emulsion of claim 6.

9. A feed product according to claim 7, which is a dry pet food, a wet pet food, a semi-moist pet food, any kind of treats, chews and snacks, dry powdered supplement, tablet supplement or a paste supplement, or a liquid product.

10. A feed product according to claim 7 which is a supplement for liquid products.

11. A feed product according to claim 7, which comprises as an additional nutritional functional ingredient L-carnitine and/or EGCG and/or resveratrol.

12. A feed product according to claim 9, which is a dry powdered supplement, which comprises the mixture of triglyceride oils in a matrix containing a carrier, a palatant and optionally other functional ingredients, and which is filled into sachet or capsule or pressed as tablet.

13. A feed product according to claim 7, which is a pet food product for cats or dogs.

14. (canceled)

15. (canceled)

16. (canceled)

17. A method for balancing and maintaining body weight and/or for reducing the fat mass in the animal, said method comprising the step of administering an effective dose of a composition according to claim 1 to the animal which is in need thereof.

18. Method according to claim 17, wherein said composition is an oil-in water emulsion which is being used in an amount sufficient to provide a daily dosage of 6 mg fat per kg body weight to about 280 mg fat per kg body weight, preferably 30 mg fat per kg body weight to about 89 mg per kg body weight of the subject to which it is to be administered.

19. Method according to claim 17, wherein the composition is administered to the animal 1 to 8 hours, preferably 1 to 5, most preferentially 1 to 4 hours before the regular diet.

20. Method according to claim 17, wherein the regular diet is a calorie restricted diet.

21. A method for reducing the weight of companion animals and for reducing the risk for regaining weight, said method comprising the steps of
a) administering to the animal for a limited period of time an effective dose of a composition comprising an active ingredient which helps to reduce weight, followed by
b) administering of an effective dose of a composition according to claim 1 for giving to the animal a prolonged feeling of satiety.

22. Method according to claim 21, wherein the composition which is used to reduce body weight comprises L-carnitine or EGCG.

23. Method according to claim 21, wherein the composition which is used to reduce the risk for regaining weight is an oil-in water emulsion which is being used in an amount sufficient to provide a daily dosage of 6 mg fat per kg body weight to about 280 mg fat per kg body weight, preferably 30 mg fat per kg body weight to about 89 mg per kg body weight, of the subject to which it is to be administered.

24. Method according to claim 23, wherein said composition is administered to the animal 1 to 8 hours, preferably 1 to 5, most preferentially 1 to 4 hours before the regular diet.

25. Method for the treatment of obesity and/or overweight, for the control of calorie or fat intake and for the prevention and treatment of cardiovascular diseases and diabetes in pets, comprising the steps of administering to the animal a feed composition according to claim 1.
